(19) United States
(12) Patent Application Publication
(10) Pub. No.: US 2023/0211668 A1
(43) Pub. Date: Jul. 6, 2023

(54) DRIVE SYSTEM AND METHOD FOR OPERATING A DRIVE SYSTEM

(71) Applicant: Robert Bosch GmbH, Stuttgart (DE)

(72) Inventors: Christoph Woll, Gerlingen (DE); Gunther Handte, Unterensingen (DE)

(21) Appl. No.: 18/000,791

(22) PCT Filed: Jul. 27, 2021
(86) PCT No.: PCT/EP2021/070920

§ 371 Date: Dec. 5, 2022

(30) Foreign Application Priority Data
Sep. 1, 2020 (DE) 10 2020 210 990.7

(51) Int. Cl. B60L 3/00; B60L 50/40; B60L 50/60; B60L 50/70; B60L 58/18; B60W 50/023

(52) U.S. Cl. CPC B60L 3/0092; B60L 3/0084; B60L 50/40; B60L 50/60; B60L 50/70; B60L 58/18; B60W 50/023; B60L 2220/42

(57) ABSTRACT

A drive system. The drive system includes a first partial drive system and a second partial drive system, each having at least one electric machine, at least one control electronics for controlling the at least one electric machine, an energy source and an energy source control unit for monitoring and controlling the energy source. The drive system includes a first drive control unit and a second drive control unit, the first drive control unit communicating with both the first partial drive system and the second partial drive system and being designed to control and monitor the drive system, and the second drive control unit communicating with both the first partial drive system and with the second partial drive system and being designed to assume the control and the monitoring of the drive system in a fault state of the first drive control unit.

### FIELD

The present invention relates to a drive system, which includes a first partial drive system and a second partial drive system, each having at least one electric machine, at least one control electronics for controlling the at least one electric machine, an energy source, and an energy source control unit for monitoring and controlling the energy source.

In addition, the present invention relates to a method for operating the drive system provided according to the present invention.

The present invention also relates to a vehicle, which includes the drive system provided according to the invention and/or which is designed to carry out the method provided according to the present invention.

### BACKGROUND INFORMATION

The drive system of electrically driven vehicles (electric vehicles, EV) is made up of an energy source, an energy source control unit, an electric machine, and an control electronics. To avoid a breakdown of autonomously driven vehicles as a result of a fault in the drive system, redundances are provided. That means that individual components are installed at least in duplicate and assume the corresponding task only if a fault has occurred, which is also known as cold redundancy, or they are configured in the drive system in such a way that they already assume the corresponding tasks in a supportive manner even in the absence of a fault, either partially or up to 50%, which is also known as warm redundancy.

If the distribution is implemented in such a way that one partial drive system drives the rear axle and a further partial drive system drives the front axle, then this already provides a certain redundancy insofar as one axle is able to continue its correct operation in the event of a fault of a component, and the vehicle can therefore continue its travel so that a breakdown of the vehicle in moving traffic is avoided. The vehicle can still drive to the right edge of the roadway, to an emergency stopping bay or to the next parking spot and safely be parked there. Different residual ranges or residual driving times mean different safe-stop levels (SSL) that are reachable. Especially in autonomously driven vehicles, the SSL plays a decisive role. The greater the SSL, the more effort and costs and space are required.

In the example, if a failure occurs in the energy source or the energy source control unit assigned to the energy source, or in the control electronics or in an electric machine that drives an axle, then the second partial drive system enables continued driving at a lower output and a shorter range.

In this case, a higher-level drive control unit, which is also referred to as a vehicle control unit (VCU), deactivates the defective partial drive system. If a fault occurs in a drive control unit, the complete partial drive system of an axle is currently also deactivated because the components can no longer be monitored, controlled or regulated.

U.S. Patent Application Publication No. US 2019/0100105 A1 describes a method for operating a fault-tolerant drive system in an electric vehicle.

Japan Patent Application No. JP 2016-196295 A describes a vehicle control system for the control of a vehicle, in particular an electrically driven vehicle.

### SUMMARY

According to the present invention, a drive system for a vehicle is provided. The drive system includes a first partial drive system and a second partial drive system. The first and second partial drive system each have at least one electric machine, at least one control electronics for controlling the at least one electric machine, an energy source, and an energy source control unit for monitoring and controlling the energy source.

According to an example embodiment of the present invention, the drive system furthermore has a first drive control unit and a second drive control unit. The first drive control unit communicates with both the first partial drive system and the second partial drive system. In the same way, the second drive control unit communicates with both the first partial drive system and the second partial drive system. A communication between the drive unit and the partial drive system is understood as a data transmission, in particular a data transmission between the drive unit and the control electronics of the electric machine and the energy source control unit. In the process, the variables from the respective control electronics, e.g., current limits at the actual state of the component, e.g., the temperature and current actually supplied to the electric machine as well as the output voltage of the control electronics, and the energy source control unit such as current limits at the actual state of the component, e.g., the charge state, temperature, ageing state, and the voltage of the energy source and additionally also error codes of the components and possibly further variables such as variables of the electric machine such as the temperature are transmitted to the drive control unit. These variables are used as input variables for the drive control unit.

The first and the second drive control unit are equipped with identical software and in each case include an operating management system, which is a function block of the respective drive control units. In addition, the two drive control units have the same input signals.

In the fault-free state, the first drive control unit serves as a master control unit and is set up for the control and monitoring of the drive system. The first drive control unit reads in the variables of the two partial drive systems. The first drive control unit controls the entire drive system and determines the setpoint torque distributions for the respective partial drive systems without the second drive control unit.

The second drive control unit serves as a slave control unit and is set up to assume the control and monitoring of the drive system when a fault state of the first drive control unit has occurred. In the fault state of the first drive control unit, the second drive control unit switches from a slave control unit to a master control unit. All required signals of both partial drive systems are available to the second drive control unit, and it is therefore capable of assuming the control and monitoring of the entire drive system and of determining the setpoint torque distributions for the first and the second partial drive system also without the first drive control unit.

In a fault state of the second drive control unit, the master function of the first drive control unit is maintained, and it also assumes the control and monitoring of the entire drive system.

The energy source is preferably embodied as a battery, which has one or more battery cell(s). The battery is preferably embodied as a lithium-ion battery.

In an advantageous manner, the energy source may also be developed as a fuel cell module, which has one or more fuel cell(s).

As an alternative, the energy source may be developed as a capacitor module, which has one or more capacitors. The capacitor may preferably be developed as a supercapacitor, (SC).

According to an example embodiment of the present invention, the first and/or the second partial drive system preferably has/have an auxiliary energy source control unit to monitor and control the energy source in each case. The respective auxiliary energy source control unit is designed to assume the monitoring and control of the energy source in the event of a fault of the energy source control unit. Variables of the energy source of the first and second partial drive system such as the battery cell voltage, battery cell current and temperature, are transmitted to the energy source control unit and auxiliary energy source control unit assigned to the respective energy sources. In the fault-free state, the energy source control unit is set up as a master control unit and designed to control and monitor its assigned energy source. The auxiliary energy source control unit serves as a slave control unit and, in a fault state of the energy source control unit, is designed to assume the control and monitoring of its assigned energy source. In the fault case of the energy source control unit, the auxiliary energy source control unit turns from a slave control unit into a master control unit. In the fault state of the auxiliary energy source control unit, the master function of the energy source control unit is maintained, and it furthermore assumes the control and monitoring of its assigned energy source.

According to an example embodiment of the present invention, the first and second drive control unit preferably communicate with the first and the second partial drive system via a communications bus such as a CAN bus. The communication between the drive control unit and the partial drive system may also take place via a point-to-point connection. In this case, the drive control unit is directly connected to the control variables of the energy source control unit and the control electronics.

The point-to-point connection and/or the communications bus preferably has/have a redundant configuration.

In addition, a method for operating the drive system according to the present invention is provided. The method provided according to an example embodiment of the present invention includes the following method steps:
Transmitting variables of the first partial drive system and the second partial drive system to the first and the second drive control unit;
controlling and monitoring the drive system by the first drive control unit in the fault-free state of the first drive control unit;
controlling and monitoring the drive system by the second drive control unit in the fault case of the first drive control unit.

The method provided according to the present invention preferably also includes the following method steps:
Transmitting variables of the energy source of the first and the second partial drive system to the energy source control unit and auxiliary energy source control unit assigned to the respective energy sources;
controlling and monitoring the energy sources of the first and the second partial drive system by the respective energy source control unit assigned to the respective energy sources in the fault-free state of the energy source control unit;
controlling and monitoring the energy sources of the first and second partial drive system by the auxiliary energy source control unit assigned to the respective energy sources in a fault state of the energy source control unit.

In addition, according to an example embodiment of the present invention, a vehicle is provided, which includes the drive system provided according to the present invention and/or which is designed to carry out the method provided according to the present invention.

With the aid of the drive system provided according to the present invention and the method provided according to the present invention, a failure of an electronic control, in this instance the drive control unit or the energy source control unit controlling the components of a partial drive system, need not necessarily lead to the deactivation of this partial drive system. If all components continue to operate without a fault, the control may be assumed in some other way. For instance, it is possible to utilize the energy available in the energy source to continue the operation of the partial drive system of the vehicle with the axle-related components, the control electronics, and the electric machines. As a result, the entire drive system is operative, which means that no restrictions have to be expected with regard to the output, driving enjoyment, time schedule adherence in the case of buses or shuttles, as well as the range, which also means that the maximum SSL is achieved.

In addition, no new hardware which could lead to high costs and a high space requirement is necessary. Only a slight adaptation of software, which is already installed on the two drive control units, is necessary, for instance for further input variables and additional wiring.

### BRIEF DESCRIPTION OF THE DRAWINGS

Example embodiments of the present invention are described in greater detail with the aid of the figures and the following description.

FIG. 1A shows a schematic representation of a drive system in the related art according to a first exemplary embodiment.

FIG. 1B shows a schematic representation of the data transmission of the drive system according to the first exemplary embodiment.

FIG. 2A shows a schematic representation of the drive system in the related art according to a second exemplary embodiment.

FIG. 2B shows a schematic representation of the data transmission of the drive system according to the second exemplary embodiment.

FIG. 3A shows a schematic representation of the drive system provided according to the present invention.

FIG. 3B shows a schematic representation of the data transmission of the drive system provided according to the present invention.

### DETAILED DESCRIPTION OF EXAMPLE EMBODIMENTS

In the following description of the exemplary embodiments of the present invention, the same or similar elements are denoted by the same reference numerals, and a repeated description of these elements is omitted in some cases. The figures depict the subject matter of the present invention merely schematically.

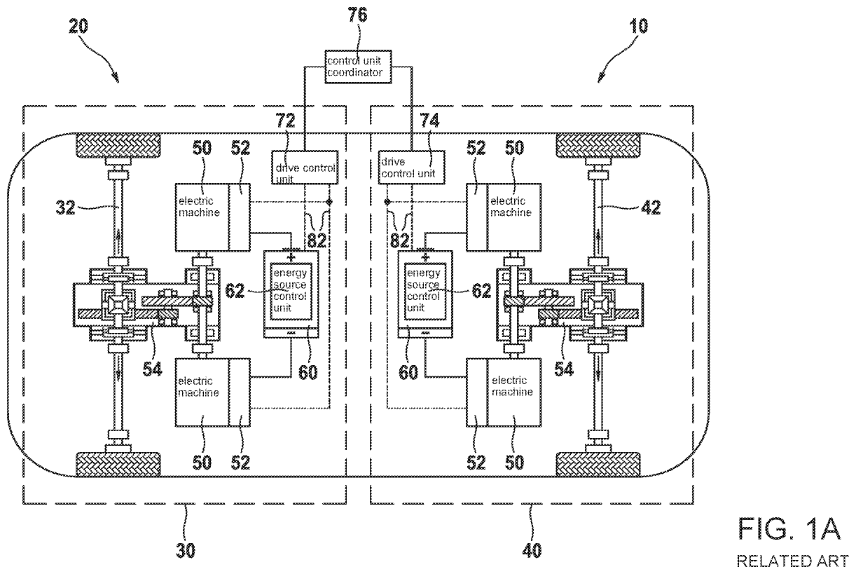

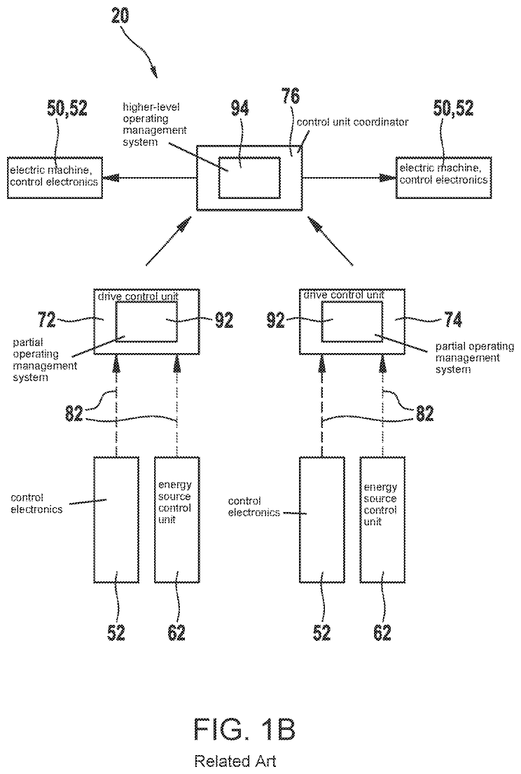

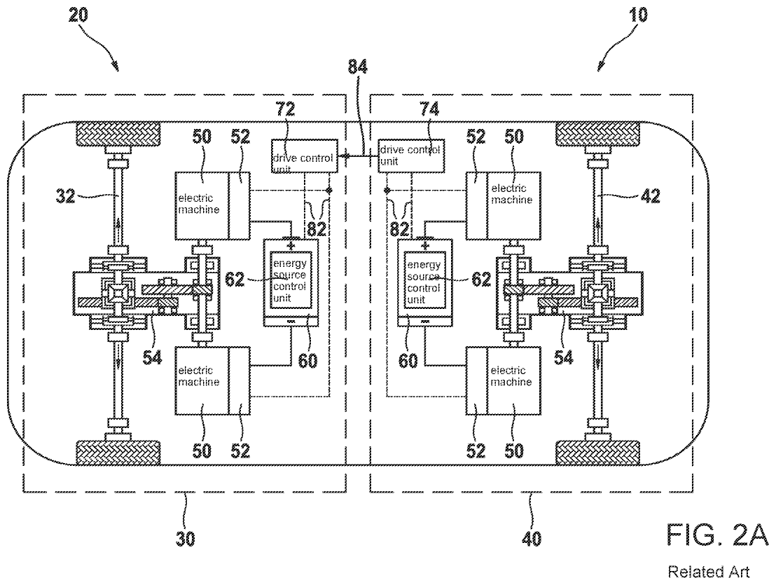

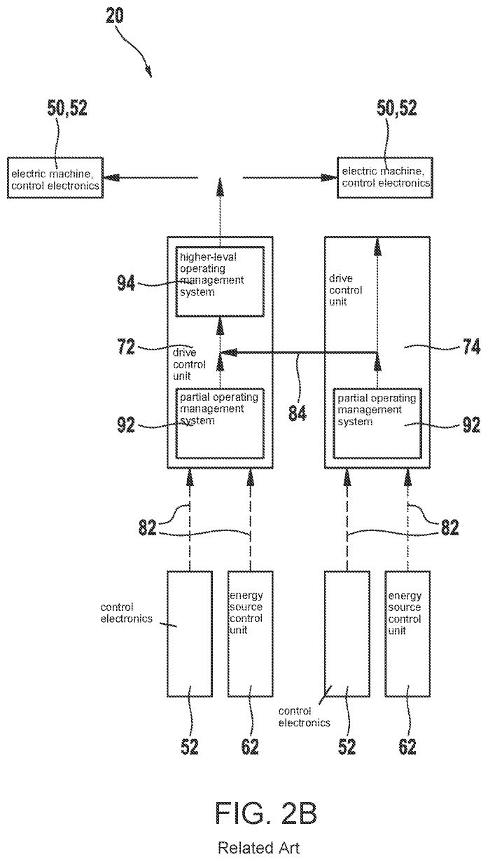

FIGS. 1A and 2A each show a schematic representation of a vehicle 10 having a drive system 20 in the related art, while FIGS. 1B and 2B each show a schematic representation of the data transmission of respective drive systems 20 according to FIGS. 1A and 2A.

Respective drive system 20 includes a first partial drive system 30 and a second partial drive system 40. First partial drive system 30 is used for driving a rear axle 32 and second partial drive system 40 is used for driving a front axle 42. First and second partial drive system 30, 40 each have two electric machines 50, which include an control electronics 52 in each case, and a gear unit 54. In addition, first and second partial drive system 30, 40 include an energy source 60 having an energy source control unit 62.

In FIGS. 1A and 1B, a first drive control unit 72 is assigned to first partial drive system 30, while a second drive control unit 74 is assigned to second partial drive system 40. Both drive control units 72, 74 must be coordinated by a drive control unit coordinator 76 and the driving behavior be optimally adjusted to the operating point. The variables from energy source control unit 62 and control electronics 52 and possibly additional variables, e.g., variables of electric machine 50 such as the temperature, serve as input variables of the respective drive control unit 72, 74. These input variables are transmitted via point-to-point connections 82 directly to respective drive control units 72, 74. Each drive control unit 72, 74 includes a partial operating management system 92, which is a function block and determines the optimal operating strategy of partial drive system 30, 40. Both drive operating units 72, 74 then report the optimal operating conditions to drive control unit coordinator 76, which has a function block, i.e., a higher-level operating management system 94. This function block determines the overall operating strategy and reports the calculated setpoint torque distributions to the respective control electronics 52 of electric machines 50. The setpoint torque distributions will all be different, depending on the loading of axles 32, 42 or of electric machines 50 and the charge states of energy sources 60, etc.

In FIGS. 2A and 2B, the structure of drive system 20 has a first drive control unit 72, which functions as a master control unit, and a second drive control unit 74, which represents a slave control unit. Both drive control units 72, 74 communicate with one another via a communications bus 84 and include the same partial operating management system 92. First drive control unit 72 controls first partial drive system 30, that is, rear axle 32, and second drive control unit 74 controls second partial drive system 40, that is, front axle 42. Only higher-level operating management system 94 is in addition and anchored only in first drive control unit 72. Each drive control unit 72, 74 processes the information supplied by the components, e.g., current limits, torque limits, etc., and has the capability of of operating the respective partial drive system 30, 40. Given two operative drive control units 72, 74, the overall operating strategy is running in first drive control unit 72, which serves as a master control unit and determines the setpoint torque distributions for all electric machines 50.

If first drive control unit 72 fails completely, then vehicle 10 is driven solely by second drive control unit 74 and its associated components. Second drive control unit 74 turns from a slave control unit into a master control unit. An axle-spanning torque distribution is therefore not required. In the reverse case, if second drive control unit 74 fails, then first drive control unit 72 remains the master control unit. In this case there is also no need to determine an overall operating strategy. In both cases, only one partial drive system 30, 40 is always active. In a fault-free operation, partial operating management system 92 of second drive control unit 74 supplies operating variables via a communications bus 84 to higher-level operating management system 94 of first drive control unit 72. A failure of communications bus 84 would likewise have the result that only first partial operating system 30, which belongs to first drive control unit 72, becomes active. To avoid a communications bus failure, a timeout, or some other communications bus fault, the communications bus has a redundant configuration.

The disadvantage of these two embodiments according to FIGS. 1A and 2A is that if only one drive control unit 72, 74 fails and energy source control unit 62 continues to operate properly, energy source 60 still has stored energy, and control electronics 52 as well as electric machines 50 are operative, partial drive system 30, 40 is no longer able to provide a torque contribution because partial drive system 30, 40 will be completely deactivated.

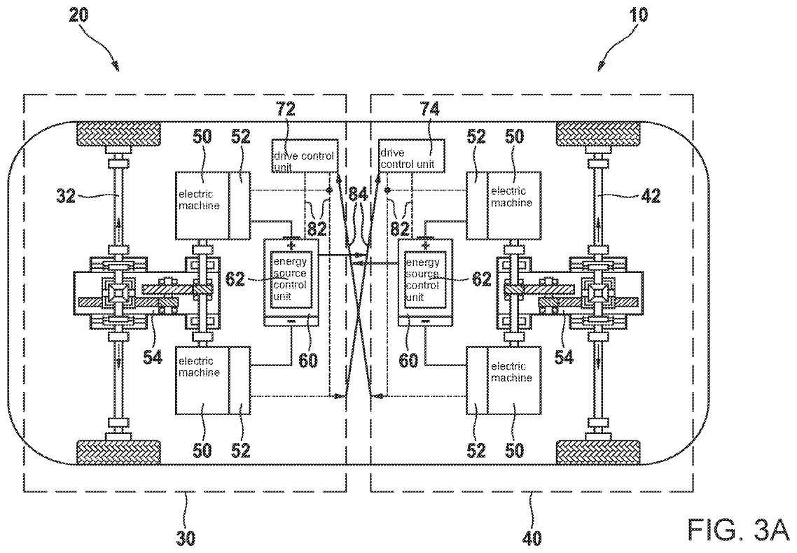

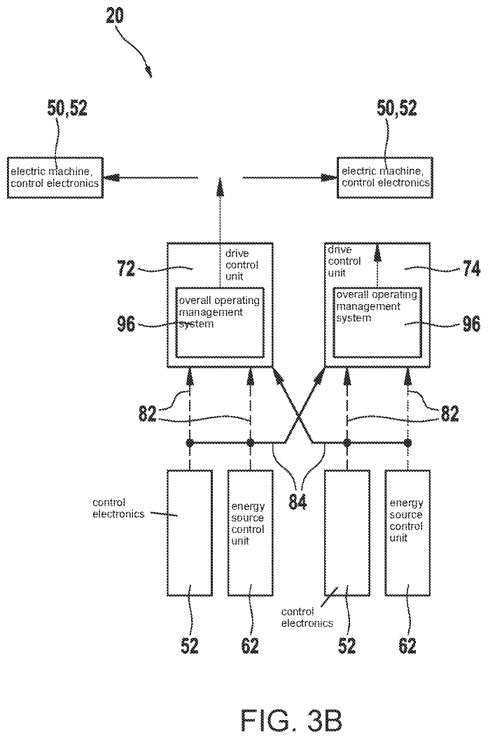

FIG. 3A shows a schematic representation of a vehicle 10 having a drive system 20 provided according to the present invention, while FIG. 3B shows a schematic representation of the data transmission of drive system 20 provided according to the present invention.

Drive system 20 according to the present invention includes a first partial drive system 30 and a second partial drive system 40. First partial drive system 30 is used to drive rear axle 32, and second partial drive system 40 is used to drive front axle 42. First and second partial drive systems 30, 40 each have two electric machines 50, which include an control electronics 52 in each case and a gear unit 54. First and second partial drive system 30, 40 furthermore have an energy source 60 including an energy source control unit 62.

Drive system 20 provided according to the present invention also includes a first drive control unit 72 and a second drive control unit 74. The two drive control units 72, 74 are equipped with an identical software and include an overall operating management system 96 in each case, which is a function block of respective drive control units 72, 74. In addition, both drive control units 72, 74 have the same input signals. In comparison with drive systems 20 shown in FIGS. 1A and 1B, first drive control unit 72, as shown in FIGS. 3A and 3B, is additionally connected to the variables of control electronics 52 and the variables of energy source control unit 62 of second partial drive system 40. Similarly, second drive control unit 74 is additionally connected to the variables of control electronics 52 and the variables of energy source control unit 62 of first partial drive system 30. As shown here, the connection may be implemented via communications bus 84 or also via-point-to-point connection 82 directly to the control variables from energy source control unit 62 and control electronics 52. The connection has a redundant configuration to provide a failure protection.

In the fault-free state, first drive control unit 72 serves as a master control unit and in addition to its own variables of first partial drive system 30, also reads in the variables of second partial drive system 40. First drive control unit 72 controls entire drive system 20 and determines the setpoint torque distributions for the first and second partial drive system 30, 40, that is, the drive of rear axle 32 and front axle 42.

In a fault state, if first drive control unit 72 fails, second drive control unit 74 assumes the control, but now no longer just the control of second partial drive system 40 but of entire drive system 20. All required signals from both partial drive systems 30, 40 are available to second drive control unit 74 so that it is capable of determining the overall operating strategy and the setpoint torque distributions also without first drive control unit 72. Second drive control unit 74 now turns from a slave control unit into a master control unit.

In a failure of second drive control unit 74, the master function of first drive control unit 72 is maintained, or in other words, first drive control unit 72 continues the control of entire drive system 20. In addition, all required signals from both partial drive systems 30, 40 are available to first drive control unit 72 so that it is capable of determining the overall operating strategy and the setpoint torque distributions also without second drive control unit 74.

As a result, the energy from energy source 60 of partial drive system 30, 40 having the defective drive control unit 72, 74 does not remain unused and is available to vehicle 10 so that it is able to reach its destination without a power restriction.

Energy source 60 may be embodied as a battery, a fuel cell module, or a capacitor module.

The present invention is not restricted to the described exemplary embodiments and to the aspects emphasized therein. Instead, a multitude of modifications that lie within the framework of actions taken by a person of ordinary skill in the art are possible within the scope of the present invention.

1-10 (canceled)

11. A drive system, comprising:
a first partial drive system and a second partial drive system, each having at least one electric machine, at least one control electronics configured to control the at least one electric machine, an energy source, and an energy source control unit configured to monitor and control the energy source; and
a first drive control unit and a second drive control unit, the first drive control unit configured to communicate with both the first partial drive system and the second partial drive system and is configured to control and monitor the drive system, and the second drive control unit configured to communicate with both the first partial drive system and the second partial drive system and is configured to assume the control and monitoring of the drive system in a fault state of the first drive control unit.

12. The drive system as recited in claim 11, wherein the energy source is a battery, which has one or more battery cells.

13. The drive system as recited in claim 11, wherein the energy source is a fuel cell module, which has one or more fuel cells.

14. The drive system as recited in claim 11, wherein the energy source is a capacitor module, which has one or more capacitors.

15. The drive system as recited in claim 11, wherein the first partial drive system and/or the second partial drive system has an auxiliary energy source control unit configured to monitor and control the energy source of the first and/or second partial drive system, the auxiliary energy source control unit configured to assume the monitoring and control of the energy source in the event of a fault of the energy source control unit.

16. The drive system as recited in claim 11, wherein the first and the second drive control unit communicate with the first and the second partial drive system via a point-to-point connection and/or a communications bus.

17. The drive system as recited in claim 16, wherein the point-to-point connection and/or the communications bus has a redundant configuration.

18. A method for operating a drive system, the drive system including:
a first partial drive system and a second partial drive system, each having at least one electric machine, at least one control electronics configured to control the at least one electric machine, an energy source, and an energy source control unit configured to monitor and control the energy source, and
a first drive control unit and a second drive control unit, the first drive control unit configured to communicate with both the first partial drive system and the second partial drive system and is configured to control and monitor the drive system, and the second drive control unit configured to communicate with both the first partial drive system and the second partial drive system and is configured to assume the control and monitoring of the drive system in a fault state of the first drive control unit;
wherein the method comprises the following steps:
transmitting variables of the first partial drive system and the second partial drive system to the first drive control unit and the second drive control unit;
controlling and monitoring the drive system by the first drive control unit in a fault-free state of the first drive control unit; and
controlling and monitoring the drive system by the second drive control unit in the fault state of the first drive control unit.

19. The method as recited in claim 18, further comprising the following steps:
transmitting variables of each energy source of the first and the second partial drive system to the energy source control unit and an auxiliary energy source control unit assigned to the energy source;
controlling and monitoring each energy source of the first and the second partial drive system by the energy source control unit assigned to the energy source in the fault-free state of the energy source control unit; and
controlling and monitoring each energy source of the first and the second partial drive system by the auxiliary energy source control unit assigned to the energy source in a fault state of the energy source control unit.

20. A vehicle, comprising:
a drive system including:
a first partial drive system and a second partial drive system, each having at least one electric machine, at least one control electronics configured to control the at least one electric machine, an energy source, and an energy source control unit configured to monitor and control the energy source; and
a first drive control unit and a second drive control unit, the first drive control unit configured to communicate with both the first partial drive system and the second partial drive system and is configured to control and monitor the drive system, and the second drive control unit configured to communicate with both the first partial drive system and the second partial drive system and is configured to assume the control and monitoring of the drive system in a fault state of the first drive control unit.

21. The vehicle as recited in claim 20, wherein the vehicle is configured to:
transmit variables of the first partial drive system and the second partial drive system to the first drive control unit and the second drive control unit;
control and monitor the drive system using the first drive control unit in a fault-free state of the first drive control unit; and
control and monitor the drive system using the second drive control unit in the fault state of the first drive control unit.
